(19) United States
(12) Patent Application Publication
(10) Pub. No.: US 2005/0200872 A1
(43) Pub. Date: Sep. 15, 2005

(54) Method of processing a print batch in a print device

(76) Inventors: Bert Newell, Meridian, ID (US); Sean Jones, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/801,189

(22) Filed: Mar. 15, 2004

(51) Int. Cl. G06F 15/00

(52) U.S. Cl. 358/1.13; 358/1.15

(57) ABSTRACT

A method of processing a print batch in a print device includes storing characteristics of a plurality of print jobs in the print batch, evaluating the characteristics of the print jobs, and independently determining a pick order, a transfer order, and a delivery order based at least in part on the print job characteristics.

### BACKGROUND

Print devices, such as ink jet printers, laser copiers, copiers, etc. are capable of forming high quality images on a variety of media. These images range from simple black and white text formed on sheets of paper to more intricate color photographic images formed on photographic media. Recent efforts have been directed to increasing the speed with which print devices are able to form images.

Some recent efforts have focused on creating devices that are able to simultaneously form a plurality of images on multiple pages of varying size and type. An image is any combination of symbols, graphics, or other marks formed on a single page or media sheet. The information associated with each individual image to be formed on a single page or media sheet is often referred to as a print job. Similarly, information associated with a group of images contained in a plurality of print jobs may be referred to as a print batch. During an image forming operation, each print batch, containing print jobs, is conveyed from a computing device to a print device.

Traditionally, after a print device receives one or more print batches, the print device sequentially identifies and processes each of the print jobs contained in the print batches. More specifically, for each image to be formed by the print device, a process of converting the image data to a renderable form is executed. This conversion often includes converting the image data into a map of individual dots. The formatted print job is then passed to a processor, which instructs the internal mechanisms of the print device to pick a media sheet on which the image is to be formed. Once the media sheet is picked, traditional print devices transfer the converted image data representing a print job to a processor, where the image data is further converted into motion and dispensing commands. A print engine of the print device then uses the motion and dispensing commands to form the desired image on the picked media sheet. After the image has been formed, the print device delivers the imaged media sheet to an external output region of the print device and the process is repeated with the next print job.

As noted above, the traditional printing process is sequentially performed according to the order each print job is received. Consequently the media picking order, the print job transfer order, and the delivery order remain constant, without taking into account the type of media sheets that are picked, the complexity of the image, or the time required to form and deliver each image.

### SUMMARY

A method of processing a print batch in a print device includes storing characteristics of a plurality of print jobs in the print batch, evaluating the characteristics of the print jobs, and independently determining a pick order, a transfer order, and a delivery order based at least in part on the print job characteristics.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 is a schematic diagram of a printing device coupled to a computing device, according to one exemplary embodiment.

FIG. 2 is a flowchart illustrating a method of processing a print batch, according to one exemplary embodiment.

FIG. 3 is a schematic diagram illustrating a picking process, according to one exemplary embodiment.

FIG. 4 is a schematic diagram showing a transfer process, according to one exemplary embodiment.

FIG. 5 is a schematic diagram illustrating a delivery process, according to one exemplary embodiment.

FIG. 6 is a flowchart illustrating a method of independently picking, transferring, and delivering a print batch, according to one exemplary embodiment.

Throughout the drawings, identical reference numbers designate similar but not necessarily identical elements.

### DETAILED DESCRIPTION

A method of processing a print batch in a print device includes storing characteristics of each print job in a print batch, evaluating the characteristics of each print job in the print batch, and independently determining a pick order, a transfer order, and a delivery order based, at least in part, on the evaluated characteristics.

Accordingly, the present method provides for the independent and dynamic determination of the pick order, the transfer order, and the delivery order of print jobs received in a print device. As a result, the pick order, the transfer order, and the delivery orders may be independent from one another and may be determined according to the specific characteristics of each print job. By independently determining the discussed orders, the present method increases the efficiency and adaptability of the processing of each print batch.

As used herein and in the appended claims, the phrase “medium” or “media” shall be broadly understood to mean any image receiving substrate, such as paper, transparency, or photographic media sheets, on which an image may be printed. The phrase “computing device” is meant to be understood as any device capable of forming and/or digitally processing images. An “image” is any pattern, text, or marks existing in data or physical form. A “print device” is meant to be understood broadly as any device capable of forming an image on a media. Similarly, a “print job” shall be broadly understood to mean any data corresponding to the formation of an image. A “print batch” shall be understood to mean data representing one or more print jobs. A “picking process” shall be broadly understood to mean any operation designed to position or otherwise prepare one or more medias to have an image formed thereon by a print device. A “transfer process” is any operation for transferring a print batch or print job for further processing beyond formatting. A “delivery process” is any operation for directing at least one imaged media to an output portion of a printing device. A delivery process may or may not include the actual imaging of the media.

In the following description, for purposes of explanation, numerous specific details are set forth in order to provide a thorough understanding of the present method and apparatus of processing a print batch in a print device. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

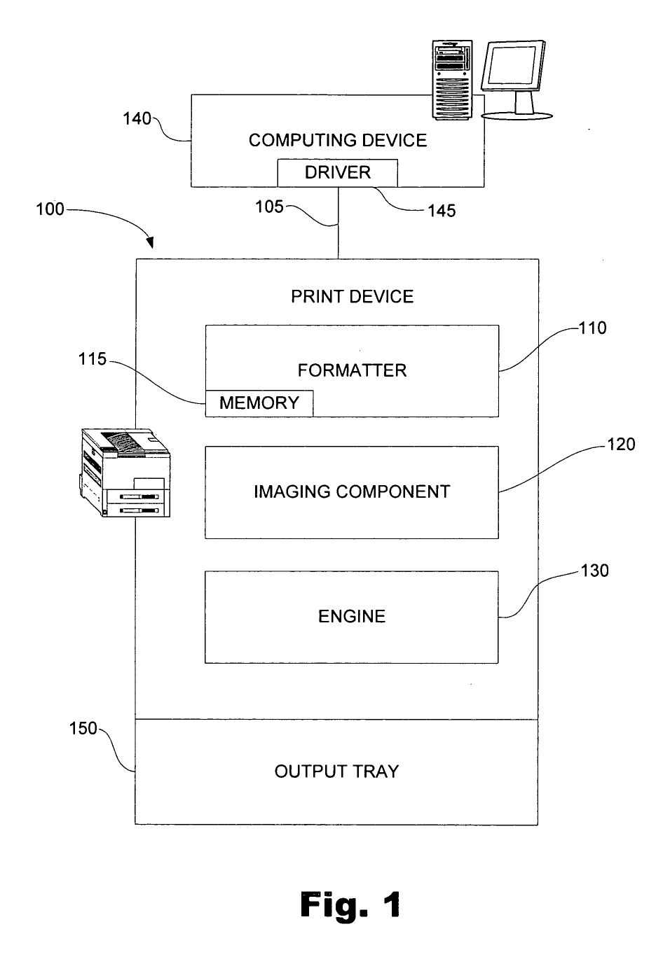

FIG. 1 is a schematic diagram illustrating the components of a print device (100) communicatively coupled to a computing device (140). According to the exemplary embodiment illustrated in FIG. 1, a print device (100) generally includes a formatter (110), an imaging component (120), and a print engine (130). The components illustrated in FIG. 1 will be described in further detail below.

As illustrated in FIG. 1, the print device (100) is communicatively coupled to a computing device (140). The computing device (140) illustrated in FIG. 1 may include any number of applications configured to receive and/or generate a desired image. According to one exemplary embodiment, the computing device (140) may be, but is in no way limited to, a personal computer, a laptop computer, a personal digital assistant (PDA), a palm computer, a tablet computer, or any other processor containing device.

When an image is formed and/or received by the computing device (140), it is transferred to the print device (100) through a driver (145) to be formatted and otherwise processed by the print device (100). The driver (145) is software that is configured to facilitate communication between the computing device (140) and the print device (100). Due to the fact that many print devices use a common language, the driver (145) acts as an interpreter between any application residing on the computing device (140) that supports the common language and the print device (100). During communication between an application on the computing device (140) and the print device (100), the driver (145) translates the data associated with an image into a format that the print device (100) can use. The driver (145) also checks to see that the print device (100) is online and available to print.

Data is transmitted between the computing device (140) and the print device (100) by the driver (145) via a connection interface (105). The connection interface (105) coupling the computing device (140) and the print device (100) may assume any number of configurations including, but in no way limited to, a single physical cable such as a universal serial bus (USB) cable, a wireless communication medium, or a network. A group of data transmitted over the connection interface (105) to the print device (100) may be described, according to one exemplary embodiment, as a print batch. Each print batch may include a plurality of computer images, each of which will be referred to herein as a print job.

After a print batch is transmitted over the connection interface (105) to the print device (100), it is received by the formatter (110). As illustrated in FIG. 1, the formatter (110) forms an integral part of the print device (100). According to one exemplary embodiment, the formatter (110) is firmware contained in the print device (100) configured to format received data representing print jobs into a form readily accepted by the print device. According to this exemplary embodiment, the formatter (110) is configured to pass the received data representing print jobs through a raster image process (RIP). The RIP creates a rasterized or dot-by-dot image of the data representing a print job. Each of the dots represents a location on an image receiving media. In the case of a color image, the rasterized data contains information indicating the location and relative amount of each color to be deposited at an identified dot location.

As illustrated in FIG. 1, the formatter (110) also includes a memory component (115). According to the present exemplary embodiment, once a rasterized print job is created, the formatter (110) pools the print jobs and stores compressed copies of the print jobs in the memory component (115). The stored copies of the rasterized print job may be compressed or uncompressed and may include a number of characteristics corresponding to each rasterized print job, as will be described below.

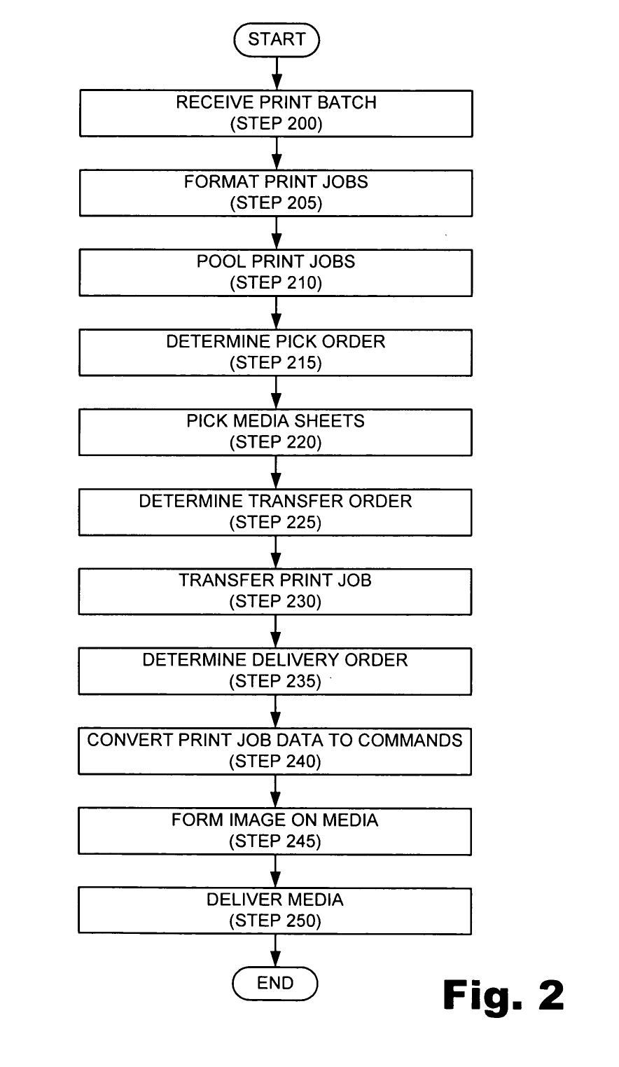

FIG. 1 also illustrates an imaging component (120) communicatively coupled to the formatter (110). The imaging component (120) is a processor configured to processes the rasterized print job and its associated information, according to one exemplary embodiment. Due to the communicative coupling of the imaging component (120) and the formatter (110), the characteristics of each print batch are accessible for analysis by the imaging component (120). When the characteristics of each print batch are accessed by the imaging component (120), the characteristics may be processed to independently determine the pick order of the pages on which the images corresponding to the print jobs are to be printed, the order in which the print jobs are to be transferred to the print engine (130), and the order in which the printed pages are to be delivered to an output region such as output tray (150). Accordingly, the present print device (100) is configured to maximize the efficiency of processing a print batch by independently ordering the picking order, the transfer order, and the delivery order of a plurality of print jobs as will be further described below with reference to FIGS. 2 through 6.

FIG. 1 also illustrates a print engine (130) communicatively coupled to the imaging component (120). The print engine (130), illustrated in FIG. 1, includes all of the moving parts of the print device (100) used to transport an image receiving media or to produce a desired image. According to one exemplary embodiment, the print engine (130) includes, but is in no way limited to, servo mechanisms, moveable carriages, inkjet material dispensers, lasers, photo drums, motors, rollers, and the like.

Once an image receiving media has received a desired image, it may be transported to an output tray (150). The output tray (150) illustrated in FIG. 1 may be any externally accessible portion of the print device (100) where a user may access a completed print job. An exemplary method of maximizing print efficiency using the above-mentioned system will be described in detail below with reference to FIGS. 2 through 6.

Exemplary Implementation and Operation

FIG. 2 is a high level flow chart illustrating a method of processing a print batch in a print device, according to one exemplary embodiment. As illustrated in FIG. 2, the method begins by receiving a print batch (step 200) in the print device. The print batch may be formed and/or transmitted by any suitable means including, but in no way limited to a computing device. As discussed above, when computer images are formed by a computing device (140; FIG. 1), the image is converted to a common language by passing the computer images through a driver (145). The driver (145) converts the computer images into a format that is compatible with the print device. According to one exemplary embodiment, the format used by the driver (145), and subsequently, the data received by the print device, may include, but is in no way limited to post script (PS) format or tagged image file format (TIFF).

Once the driver formatted print batch containing a plurality of print jobs is received by the print device (step 200), the print batch is transmitted to the formatter (110; FIG. 1) where the individual print jobs of the print batch are formatted (step 205). As described above, the formatting performed by the formatter may include, but is in no way limited to, performing a raster image process (RIP). As noted above, the RIP produces a rasterized representation of the individual print jobs as well as characteristic data corresponding to each print job.

In addition to formatting the computer images (step 205), the formatter also pools the images of the print batch (step 210). Pooling the print batch includes holding or storing the characteristics and information related to each rasterized print job contained in the print batch in the memory component (115; FIG. 1) of the formatter. As noted above with reference to FIG. 1, the imaging component (120; FIG. 1) of the print device (100; FIG. 1) is communicatively coupled to the formatter (110; FIG. 1). Consequently, the characteristics of each of the print jobs contained in the print batch are made available to the imaging component (115; FIG. 1). As will be discussed in more detail below, this access to print job characteristics allows the print device to determine how each print batch may be most efficiently processed. As a result, the print device may efficiently vary the performing of each printing operation rather than sequentially processing each print job based on the order in which they were received.

As illustrated in FIG. 2, the imaging component (120; FIG. 1) of the print device (100; FIG. 1) evaluates the characteristics of the print batch stored in the memory component (115; FIG. 1) and uses the evaluation to determine the media pick order (step 215). According to this exemplary embodiment, the image receiving media to be used for each print job may be selected by the imaging component (120; FIG. 1) based on the above-mentioned image characteristics. Once the pick order is determined (step 215), the print engine (130; FIG. 1) is directed to physically pick the requested media (step 220), according to the order determined by the imaging component (step 215).

Once the pick order is determined, the imaging component (120; FIG. 1) analyzes the print job characteristics to optimize the order in which the print jobs pooled in the formatter (110; FIG. 1) are to be transferred to the imaging component (120; FIG. 1) for further processing (step 225). The determination of the transfer order may be based, at least in part, on print job characteristics such as the complexity of the print job or on the estimated time that would be required to transfer the print job from the formatter (110; FIG. 1) to the imaging component (120; FIG. 1). For example, some print jobs include data for forming complex images, such as color photographic images, that may take a relatively long time to transfer when compared to simpler images, such as black text images. In such a case, the imaging component (120; FIG. 1) may determine for efficiency arguments that a transfer of the complex print job should begin first. Additionally, the imaging component (120; FIG. 1) may determine that a transfer of the simpler print job will take place after transfer of the complex print job had begun, but before its completion. Moreover, if the print batch includes a print job of an intermediate complexity, the transfer of the intermediate print job may begin before the simplest print job, but after the more complex print job. While one exemplary print job transfer order is illustrated above based on print job complexity, a print batch may include any number or print jobs and the transfer order may be determined based on any number of characteristics.

Once the transfer order is determined, according to the characteristics (step 225), the print jobs are transferred to the imaging component (step 230), accordingly. As previously discussed, a transfer of more complex print jobs may begin before the transfer of the simpler print jobs. As a result, the transfer of the more complex print jobs may govern the transfer time. For example, after the transfer of the more complex image has begun, the imaging component can request that the simpler print jobs be sent as the transfer of the complex print job progresses. Consequently, the transfer of all of the print jobs may be completed at substantially the same time, if such a transfer would be desirable.

After the print jobs have been transferred to the imaging component (step 230), the imaging component evaluates the print batch to determine the delivery order that the final finished or physically imaged pages are to be formed and delivered (step 235). This determination may be based, at least in part, on print job characteristics such as the time required to print or image the pages or a priority associated with each print job. The time required to image the pages may depend on the complexity of the image, the type of marking material used, or other media or marking material variables.

When the delivery order has been determined, the print jobs are then further processed to convert the rasterized data of the print jobs into commands that are understood by the print engine (step 240). According to this exemplary embodiment, the rasterized print job data is converted into a plurality of position, motion, and dispensing information/commands. Once formed, these commands are sent to the print engine to form images on the above-mentioned image receiving media (step 245). In the case of an inkjet type print device, the requested images are formed by ejecting tiny droplets of ink, or dots, during each horizontal pass of a print head over the image receiving media. The position and orientation of the ink dots may correspond to the rasterized print job, previously discussed.

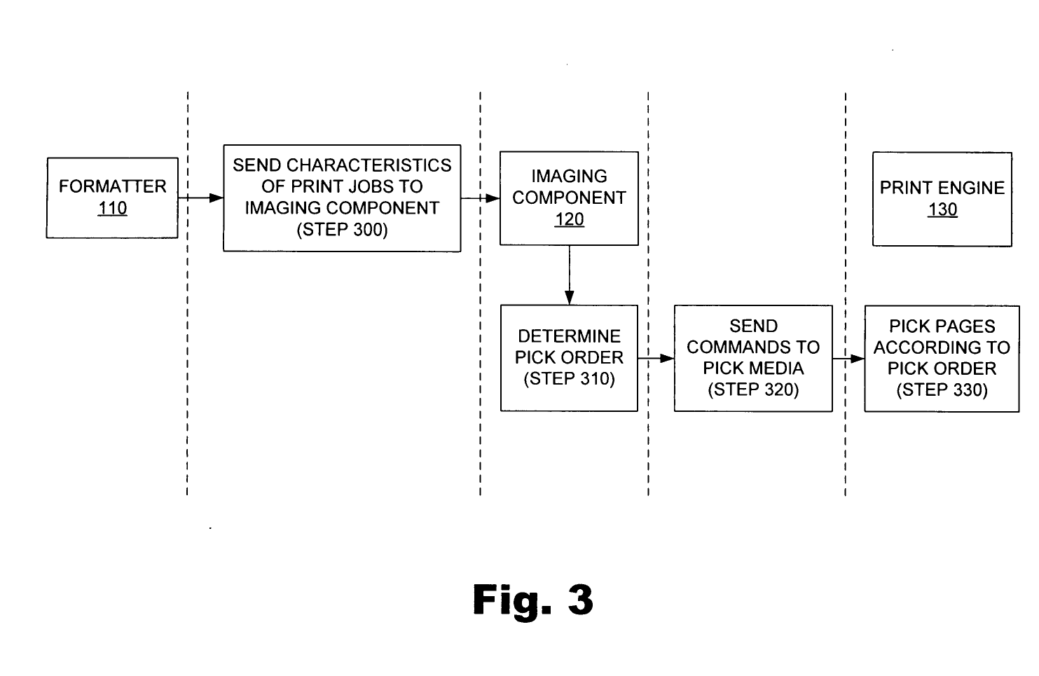

After the desired image has been formed on the image receiving media, the print engine (130; FIG. 1) delivers the image receiving media, with the physical images formed thereon, to an output region (step 250). Accordingly, the present method allows for the independent determination of the picking, transfer, and delivery orders to optimize or otherwise vary the printing process. The steps described above will now be discussed in more detail with reference to FIGS. 3-5.

FIG. 3 is a schematic diagram further illustrating the picking process introduced in FIG. 2 (steps 200-220). The schematic diagram of FIG. 3 illustrates the formatter (110), the imaging component (120), and the print engine (130) separated by spaces between dashed lines. The placement of a process below a component is intended to indicate that the process occurs in, or is performed by the above component. Similarly, processes shown between the components are intended to indicate that the process, command, or signal is being conveyed or transferred between the identified components.

As previously discussed, the print jobs of the print batch are initially processed by the formatter (110). After initially formatting the print batch, the formatter (110) is accessed, or transmits the characteristics of the print jobs to the imaging component (step 300). The imaging component (120) then evaluates the characteristics of the print jobs to determine the picking order (step 310).

The characteristics conveyed to the imaging component (120) by the formatter may include, but is in no way limited to, information about the nature of the print jobs, including information about the media on which the images are to be formed, the size of the print jobs in terms of memory space required, and other characteristics including the color scheme, if applicable, of the print job. As will be discussed in more detail below, the imaging component (120) evaluates these characteristics to independently determine the pick order, the transfer order, and the delivery order.

In the case of the picking process illustrated in FIG. 3, the characteristics processed by the imaging component (120) may include the dimensions of the media sheet or processing requirements. For example, a relatively large media sheet may require a longer time to pick. Further, some types of media sheets may require additional processing during picking, such as heating or retrieving the media sheet from a relatively distant paper tray. The characteristics are evaluated by the imaging component (120) to determine the ideal picking process as governed by efficiency, priority, or some other guiding theory.

Once the pick order has been determined (step 310), the imaging component (120) sends commands to the print engine (130) to pick the image receiving media (step 320). These commands may include motion commands for the mechanical systems of the print engine (130) to advance the media sheets. According to one exemplary embodiment, the commands are configured to cause one or more pick-up rollers to contact and translate a desired image receiving media.

In response to the received commands, the print engine (130) then picks the desired image receiving media (step 330), according to the determined pick order. Picking the image receiving media may include moving the individual image receiving media sheets into position to have images formed thereon. As previously discussed, this picking order may be determined so as to maximize the efficiency of the printing operation. Once the desired image receiving media is picked, the transfer process may be performed.

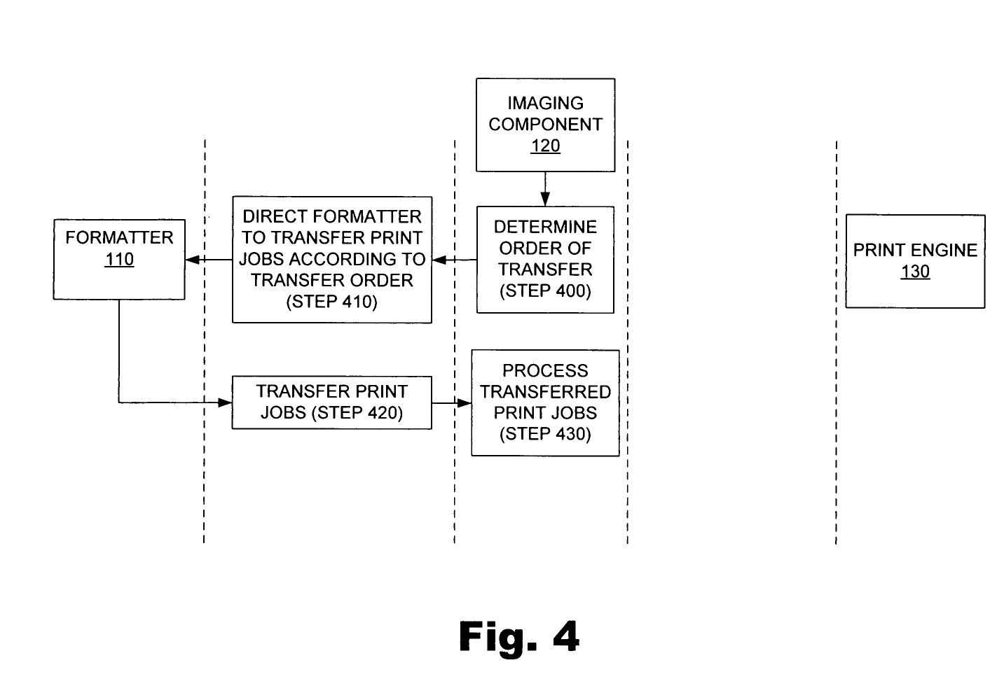

FIG. 4 is a schematic diagram further illustrating the transfer process introduced in FIG. 2 (steps 225-230), according to one exemplary embodiment. After the picking process described above with reference to FIG. 3 has finished, or concurrently with the picking operation, the imaging component (120) evaluates the print batch characteristics to determine a desired transfer order of the rasterized print jobs (step 400) from the formatter (110) to the imaging component (120).

When the order of the transfer process is to be determined as illustrated in FIG. 4, the print job characteristics may be stored on the imaging component (120) above, or again accessed from the formatter (110). Based on the print job characteristics, the imaging component (120) determines the order that the images will be transferred (step 400). The characteristics used by the imaging component (120) to determine the transfer order may include, but are in no way limited to, the size and complexity of each of the print jobs. As a result of the analysis by the imaging component (120), the imaging component directs the formatter (110) to transfer the print jobs (step 410), according to a determined transfer order (step 410).

Once the command is received by the formatter (110), the formatter transfers the print jobs (step 420) to the imaging component (120). As previously discussed, relatively complex print jobs may take a relatively long time to transfer. Accordingly, transfer of the relatively complex print jobs of a print batch may be initiated before the transfer of the less complex print jobs, resulting in a more efficient transfer operation.

Further, the determination of the order that the print jobs are transferred to the imaging component (120) may be performed independently of the picking and delivery processes. For example, a print batch may include a first print job to form a photographic image on a relatively small media sheet and a second print job to form a text image on a legal sized media sheet. In such a case, the media sheet for the second print job may be picked first, based on size, while the first print job may be transferred first based on an estimated data transfer time.

Once the print jobs have been transferred to the imaging component (120), the imaging component (120) further processes the print jobs (step 430). This further processing may include converting the data of the print jobs to servo commands that are understood by the print engine (130).

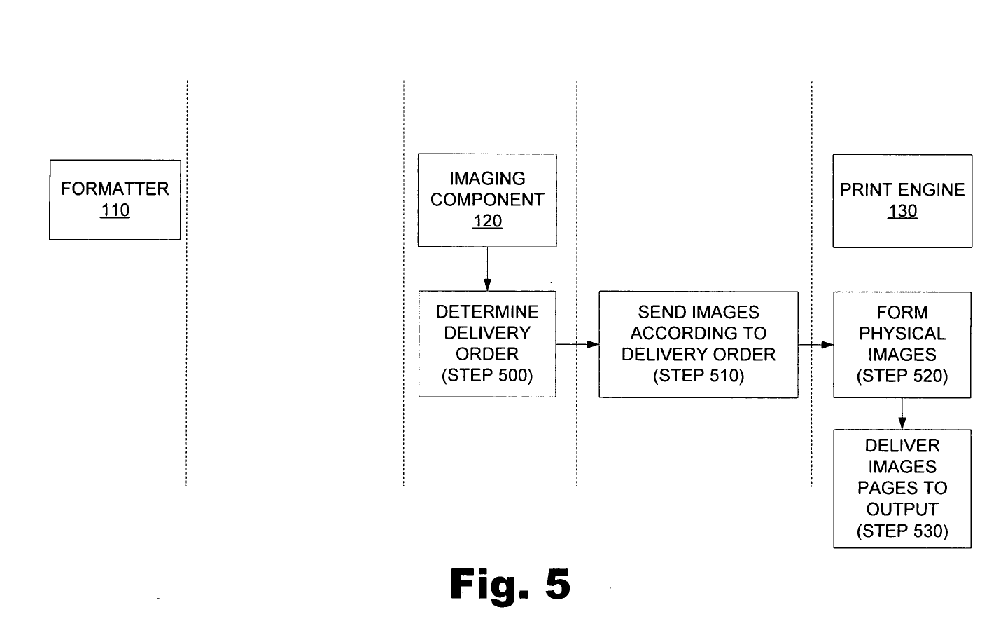

With the commands processed, the printing and delivery process may be performed. FIG. 5 is a schematic diagram showing the printing and delivery processes introduced in FIG. 2 (steps 235-250) in further detail. In addition to utilizing the characteristics conveyed to the imaging component (step 300; FIG. 3) to determine the picking order and the delivery order, the imaging component (120) uses the print job characteristics to independently determine the delivery order (step 500). The above-mentioned conversion of the print job data into servo commands (step 420; FIG. 4) may occur before, after, or simultaneously with the determination of the delivery order (step 500).

Once the data contained in the print jobs has been converted into commands (step 430; FIG. 4) and the delivery order has been determined (step 500), the commands of each of the print jobs are sent to the print engine (130), according to the delivery order (step 510). The commands of each of the print jobs include motion and/or dispensing commands. The print engine forms images on the corresponding media sheets in response to the servo commands (step 520) and delivers the finished imaged media sheets to an output region, such as an output tray (step 530).

As previously discussed, the picking order and the transfer order may be independently determined. In addition, the delivery order may be separately determined of both the picking order and the transfer order. Consequently, if the prevailing rules so require, it may be possible that the picking order, the transfer order, and the delivery order are each distinct from one another.

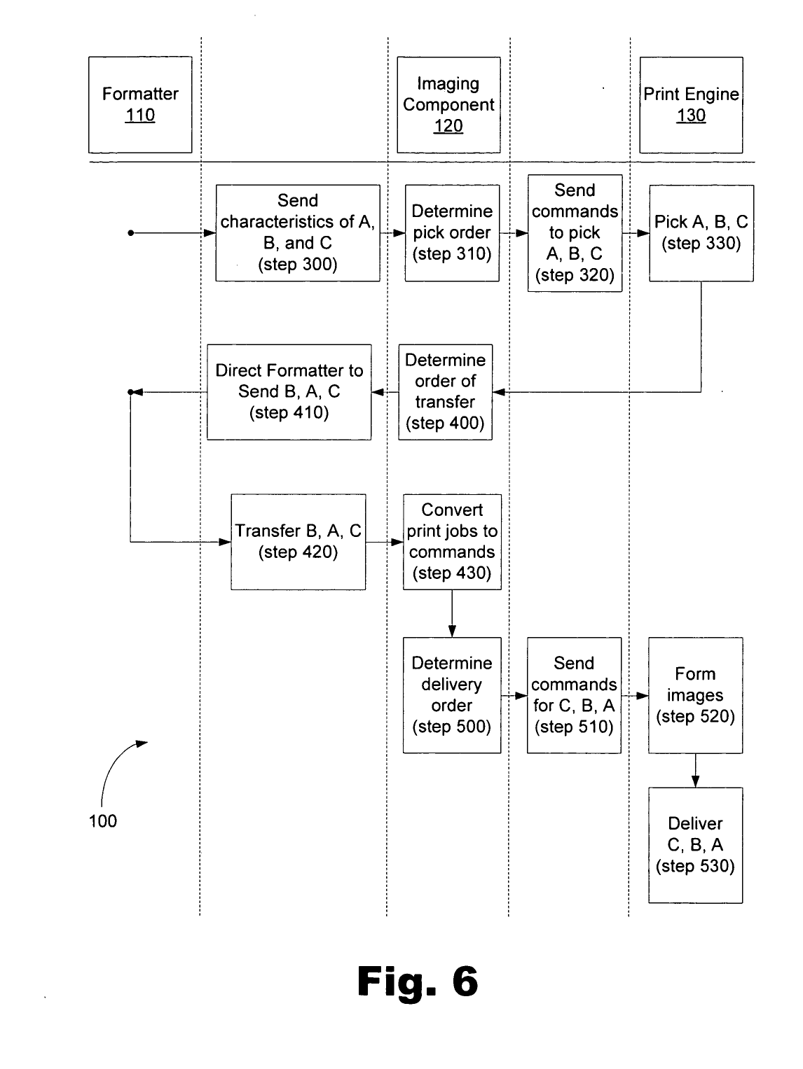

One example of an entire processing operation is shown in FIG. 6 according to one exemplary embodiment. As seen in FIG. 6, the print batch includes three print jobs, nominally labeled as A, B, and C respectively. The individual processes shown in FIGS. 3-5 are combined in FIG. 6 to illustrate a complete process. As shown in FIG. 6, the picking order may be such that A is picked first, B is picked second, and C is picked third (step 330). In addition, the transfer order may be such that B is transferred first, A is transferred second, and C is transferred third (step 420). Further, the delivery order may be such that C is delivered first, B is delivered second, and A is delivered third (step 530). Accordingly, the present method allows for independent determination of each of the picking, transfer, and delivery orders. In some cases, these orders may be different from one another. In other cases, the delivery order may be the same.

In conclusion, the present method and system allow for efficient processing of a print batch by allowing the independent determination of the pick, transfer, and delivery orders to optimize efficiency or another desired characteristic. While the exemplary implementation illustrated in FIG. 6 included three print jobs in a single batch, any number of print jobs and/or print batches may be optimized with the present method. Further, in the illustrated implementations, the imaging component was responsible for processing the characteristics of the print batch. Those of skill in the art will appreciate that any processor or processing device may perform the order determinations.

The preceding description has been presented only to illustrate and describe the present method and apparatus. It is not intended to be exhaustive or to limit the system and method to any precise form disclosed. Many modifications and variations are possible in light of the above teaching. It is intended that the scope of the invention be defined by the following claims.

1. A method of processing a print batch in a print device, comprising:
storing characteristics of a plurality of print jobs contained in said print batch;
evaluating said characteristics of said print jobs; and
independently determining a pick order, a transfer order, and a delivery order based, at least in part, on said characteristics.

2. The method of claim 1, wherein said characteristics are stored on a memory storage device.

3. The method of claim 1, wherein said characteristics comprise an image receiving media type, an image size, an image processing time, or an image forming time.

4. The method of claim 1, wherein evaluating said characteristics is carried out by a processor residing on said print device.

5. The method of claim 4, wherein said processor comprises an imaging component.

6. The method of claim 1, further comprising forming at least one image corresponding to each of said print jobs on an image receiving media

7. The method of claim 6, wherein said images are formed according to said delivery order.

8. A method of processing a print batch in a print device, comprising:
storing a print batch that includes a plurality of print jobs;
evaluating characteristics of said print batch to determine a pick order;
picking media sheets according to said pick order;
evaluating said characteristics to determine a transfer order of said print jobs from a formatter to an imaging component;
transferring said print jobs from said formatter to said imaging component based on said transfer order;
forming images corresponding to said print jobs on media sheets;
evaluating said characteristics to determine a delivery order of said media sheets; and
delivering said media sheets to an output portion of said print device based on said delivery order.

9. The method of claim 8, wherein said print batch is stored on a data storage device of said formatter.

10. The method of claim 8, wherein said characteristics comprise an image receiving media type, an image size, an image processing time, or an image forming time.

11. The method of claim 8, wherein said characteristics are evaluated by an imaging component to determine said pick order, said transfer order, and said delivery order.

12. The method of claim 8, wherein a print engine picks said media sheets.

13. The method of claim 8, wherein a print engine forms said images and delivers said media sheets.

14. The method of claim 8, forming said images includes using said imagine component to convert data contained in said print job to commands; conveying said commands to a print engine, and forming said images in response to said commands.

15. A print device, comprising:
a formatter configured to pool a batch of print data, wherein said batch includes a plurality of print jobs;
a processor having an imaging component residing thereon, wherein said imaging component is configured to access said batch information and to independently determine a pick order, a transfer order, and a delivery order of said print jobs; and
a print engine configured form images on a plurality of media corresponding to said print jobs.

16. The print device of claim 15, wherein said formatter is configured to perform raster image processing.

17. The print device of claim 15, wherein said print engine comprises an inkjet print head.

18. The print device of claim 15, wherein said print engine is configured to pick said media according to said pick order and to deliver said media according to said delivery order.

19. A printing system, comprising:
means for evaluating characteristics of a print batch; and
means for independently determining a pick order, a transfer order, and a delivery order based on said characteristics.

20. The system of claim 19, and further comprising means for picking media according to said pick order, transferring print jobs of said print batch according to said transfer order, and delivering said media according to said delivery order.

21. The system of claim 19, and further comprising means for forming an image on said media.
